(19) United States
(12) Patent Application Publication
(10) Pub. No.: US 2008/0115493 A1
(43) Pub. Date: May 22, 2008

(54) Diesel combustion engine having a low pressure exhaust gas recirculation system employing a corrosion resistant aluminum charge air cooler

(76) Inventors: Eric P. Wolf, Racine, WI (US); David S. Peterson, Racine, WI (US); C. James Rogers, Racine, WI (US)

Correspondence Address: MICHAEL BEST & FRIEDRICH LLP, 100 E WISCONSIN AVENUE, Suite 3300, MILWAUKEE, WI, 53202, US

(21) Appl. No.: 11/601,533

(22) Filed: Nov. 17, 2006

(51) Int. Cl. F02B 33/44

(52) U.S. Cl. 60/605.2; 60/599; 123/195 R

(57) ABSTRACT

A diesel engine system (10) includes a diesel combustion engine (12), an exhaust gas driven turbine (14), an exhaust gas recirculation loop (16), an intake gas compressor (18), a corrosion resistant charge air cooler (CAC) (20), and a diesel particulate filter (DPF) (22). The intake gas flow path (50) in the charge air cooler (20) is defined by a multi-layer material (64, 68) having an inner surface that is wetted by the intake gas flow (30). The multi-layer material (64, 68) has a core layer (80) of corrosion resistant aluminum and at least one layer (82) of high purity aluminum.

### CROSS-REFERENCE TO RELATED APPLICATIONS

Not Applicable.

### FEDERALLY SPONSORED RESEARCH OR DEVELOPMENT

Not Applicable.

### MICROFICHE/COPYRIGHT REFERENCE

Not Applicable.

### FIELD OF THE INVENTION

This invention relates to diesel engine systems that include an Exhaust Gas Recirculation system.

### BACKGROUND OF THE INVENTION

In view of current and/or anticipated emissions regulations, some diesel engine manufacturers are proposing low pressure Exhaust Gas Recirculation (EGR) systems as an alternative to the more conventional high pressure EGR systems. In high pressure EGR systems, the exhaust gas flow is recirculated back into the charge air flow downstream from the Charge Air Cooler (CAC). In low pressure systems, the recirculated exhaust gas flow is mixed with the charge air flow upstream of the CAC, rather than downstream from the CAC as in high pressure systems. For typical engine systems, under the majority of engine and environmental conditions, some water vapor from the intake air and the recirculated exhaust gas will condense due to the CAC cooling the mixture of intake air and exhaust gas below the dew point of the mixture. Because this condensate is acidic due to the formation of nitric and sulfuric acid from the components in the exhaust gas, material corrosion is a problem in the CAC flow passages that are wetted by the mixture of intake air and exhaust gas.

### SUMMARY OF THE INVENTION

In accordance with one feature of the invention, a diesel combustion engine system includes a diesel combustion engine, an exhaust gas driven turbine, an exhaust gas recirculation loop, an intake gas compressor, and a charge air cooler. The diesel combustion engine includes an intake gas manifold for directing an intake gas flow to the engine for combustion and an exhaust gas manifold for directing a combustion exhaust gas flow from the engine.

According to one feature of the invention, a low pressure exhaust gas recirculation system is provided for use with a diesel combustion engine having an intake gas manifold for directing an intake gas flow to the engine for combustion and an exhaust gas manifold for directing a combustion exhaust gas flow from the engine. The exhaust gas recirculation system includes an exhaust gas driven turbine, an exhaust gas recirculation loop, an intake gas compressor, and a charge air cooler.

As one feature, the exhaust gas driven turbine is connected to the exhaust manifold to receive pressurized exhaust gas flow therefrom, and the exhaust gas recirculation loop is connected to the turbine to receive reduced pressure exhaust gas flow therefrom and includes an exhaust gas cooler. The intake gas compressor is connected to an air inlet and the exhaust gas recirculation loop to receive an intake gas flow including an air flow from the air inlet and a cooled exhaust gas flow from the exhaust gas recirculation loop. The intake gas compressor is driven by the turbine to provide a pressurized flow of the intake gas. The charge air cooler is connected to the compressor to receive the pressurized intake gas flow therefrom and to the intake manifold to supply a cooled pressurized intake gas flow thereto. The cooler includes an intake gas flow path for directing the intake gas flow in heat exchange relation with a cooling fluid flow through the cooler. The intake gas flow path is defined by a five layer material having an inner surface wetted by the intake gas flow. The five layers of the material consists of a core layer of corrosion resistant aluminum, a pair of liner layers of high purity aluminum (having no more than 0.4% by weight of impurities other than silicon) located against either side of the core layer, and two outer layers of braze cladding, one outer layer overlying the one of the liner layers and the other outer layer overlying the other of the liner layers. In highly preferred embodiments, the high purity aluminum has no more than 0.3% by weight of impurities other than silicon. With respect to the impurities, it is preferred that iron be no more than 0.3% by weight, and in highly preferred embodiments, 0.18% or less, and in even more highly preferred embodiments, 0.10% iron or less; manganese is preferably 0.1% by weight or less and in even more highly preferred embodiments, 0.001% or less by weight; and the weight percentage of silicon is preferably selected so as to obtain a desired electrochemical potential with respect to the other layers and/or to help ensure appropriate bonding. In this regard, while in some embodiments silicon can be 1.5% or more by weight, in most preferred embodiments, silicon will be 1.5% or less by weight, with the silicon being 1.0% or less by weight in some preferred embodiments, and the weight percentage of silicon will be anywhere in the range of 0.4% to 0.1% in some highly preferred embodiments.

In one feature, the braze cladding is selected from the group consisting of 4000 series aluminum silicon alloys. As a further feature, the braze cladding is 4343 if CAB brazing is to be used, and 4104 is vacuum brazing is to be used.

In accordance with one feature, the core layer is a modified 3000 series aluminum manganese alloy.

According to one feature, the exhaust gas driven turbine is connected to the exhaust manifold to receive pressurized exhaust gas flow therefrom, and the exhaust gas recirculation loop is connected to the turbine to receive reduced pressure exhaust gas flow therefrom and includes an exhaust gas cooler. The intake gas compressor is connected to an air inlet and the exhaust gas recirculation loop to receive an intake gas flow including an air flow from the air inlet and a cooled exhaust gas flow from the exhaust gas recirculation loop. The intake gas compressor is driven by the turbine to provide a pressurized flow of the intake gas. The charge air cooler is connected to the compressor to receive the pressurized intake gas flow therefrom and to the intake manifold to supply a cooled pressurized intake gas flow thereto. The cooler includes an intake gas flow path for directing the intake gas flow in heat exchange relation with a cooling fluid flow through the cooler. The intake gas flow path is defined by a multi-layer material having an inner surface that is wetted by the intake gas flow. The multi-layer material has a core layer of corrosion resistant aluminum sandwiched between two layers of high purity aluminum having no more than 0.4% by weight of impurities other than silicon.

In one feature, the multi-layer material further includes at least one outer layer the braze cladding selected from the group consisting of aluminum silicon.

According to one feature, the core layer is selected from the group of aluminum alloys consisting of modified 3000 series aluminum manganese alloy.

As one feature, the core layer is Alcoa 0359 alloy. The composition of this alloy is as follows:
0.20% maximum by weight of silicon;
0.35% maximum by weight of iron;
0.40% to 0.60% by weight copper;
1.0% to 1.3% by weight manganese;
0.20% to 0.30% by weight magnesium;
0.05% maximum by weight zinc;
0.10% to 0.25% by weight titanium;
with the balance being aluminum.

In accordance with one feature, the high purity aluminum has impurities other than silicon in the range of 0.3% to 0.1% by weight.

Other objects, features, and advantages of the invention will become apparent from a review of the entire specification, including the appended claims and drawings.

### BRIEF DESCRIPTION OF THE DRAWINGS

FIG. 1 is a somewhat diagrammatic representation of a diesel engine system including a low pressure exhaust gas recirculation system employing a corrosion resistant aluminum charge air cooler embodying the present invention; and

FIG. 2 is a partial, section view taken from line 2-2 in FIG. 1 showing selective flow passages through the charge air cooler;

FIGS. 3A and 3B, 4A and 4B, and 5A and 5B are sections of comparative coupons samples resulting from corrosion testing of standard materials versus the materials used in the charge air cooler of FIGS. 1 and 2.

### DETAILED DESCRIPTION OF THE PREFERRED EMBODIMENT

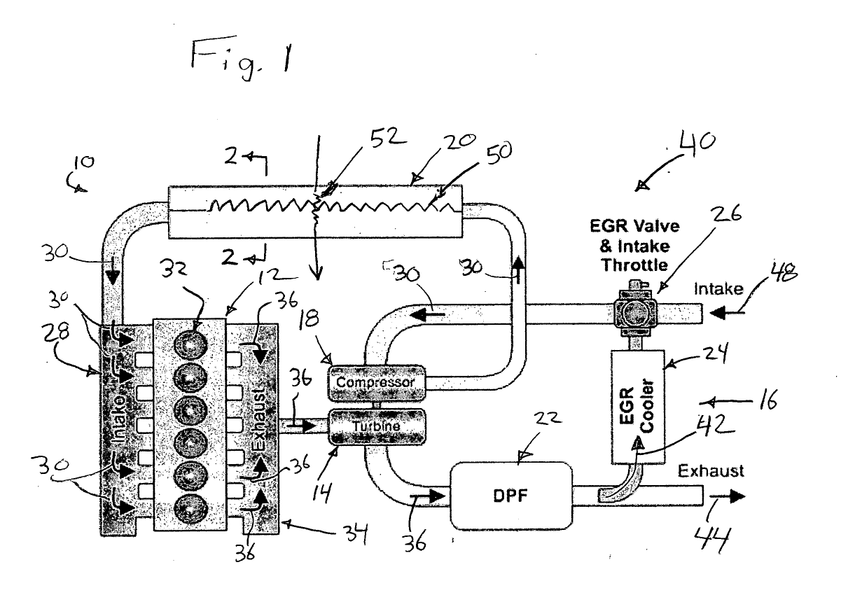

With reference to FIG. 1, a diesel engine system 10 includes a diesel combustion engine 12, an exhaust gas driven turbine 14, an exhaust gas recirculation loop 16, an intake gas compressor 18, a charge air cooler (CAC) 20, and a diesel particulate filter (DPF) 22. The exhaust gas recirculation loop includes an exhaust gas recirculation cooler 24 and an exhaust gas recirculation valve and intake throttle 26. The engine 12 includes an intake gas manifold 28 for directing an intake gas flow, shown by arrows 30, to the engine 12 for combustion in one or more combustion chambers or cylinders 32, and an exhaust gas manifold 34 for collecting a combustion exhaust gas flow, as shown by arrows 36, from the combustion chambers 32 and directing the combustion exhaust gas flow 32 from the engine 12. Together, the exhaust gas driven turbine 14, the exhaust gas recirculation loop 16, the intake gas compressor 18, and the charge air cooler 20 form a low pressure exhaust gas recirculation system 40 for the engine 12. It should be appreciated that while preferred forms of the engine system 10 and EGR system 40 are shown, there are other possible alternatives. For example, the DPF 22 may not be desired in all applications, or may only be required in the EGR loop 16. As another example, while the EGR valve and intake throttle 26 are shown as one unit, in some applications it may be desirable to provide them as separate units. Accordingly, no limitation to a specific form or construction of the systems 10 and 40 is intended unless specifically recited in the claims.

In operation, the intake gas flow 30 is combusted in the chambers 32 and then directed to the turbine 14 by the exhaust manifold 34. The relatively high pressure exhaust gas flow 32 is expanded across the turbine 14 to produce a driving torque for the compressor 18. The reduced pressure exhaust gas flow 36 then flows through the DPF 22 before being divided into a recirculated gas flow, shown by arrow 42, that is recirculated through the EGR loop 16, and a remainder 44 of the flow that is exhausted from the system 10. The EGR valve and intake throttle 26 controls the proportion of the exhaust gas flow 36 that is recirculated through the EGR loop 16. The recirculated exhaust gas flow 42 mixes with an intake air flow, shown by arrow 48, to produce a mixture in the form of the intake gas flow 30. The intake gas flow 30 is pressurized in the compressor 18 before being directed to the CAC 20 where the pressurized, intake gas flow 30 is directed by a flow path 50 in heat exchanger relation with a cooling fluid flow, typically air, flowing through a flow path 52 so as to transfer heat to the cooling fluid flow. The cooled, pressurized intake gas flow 30 is then directed to the combustion chambers 32 by the intake manifold 28.

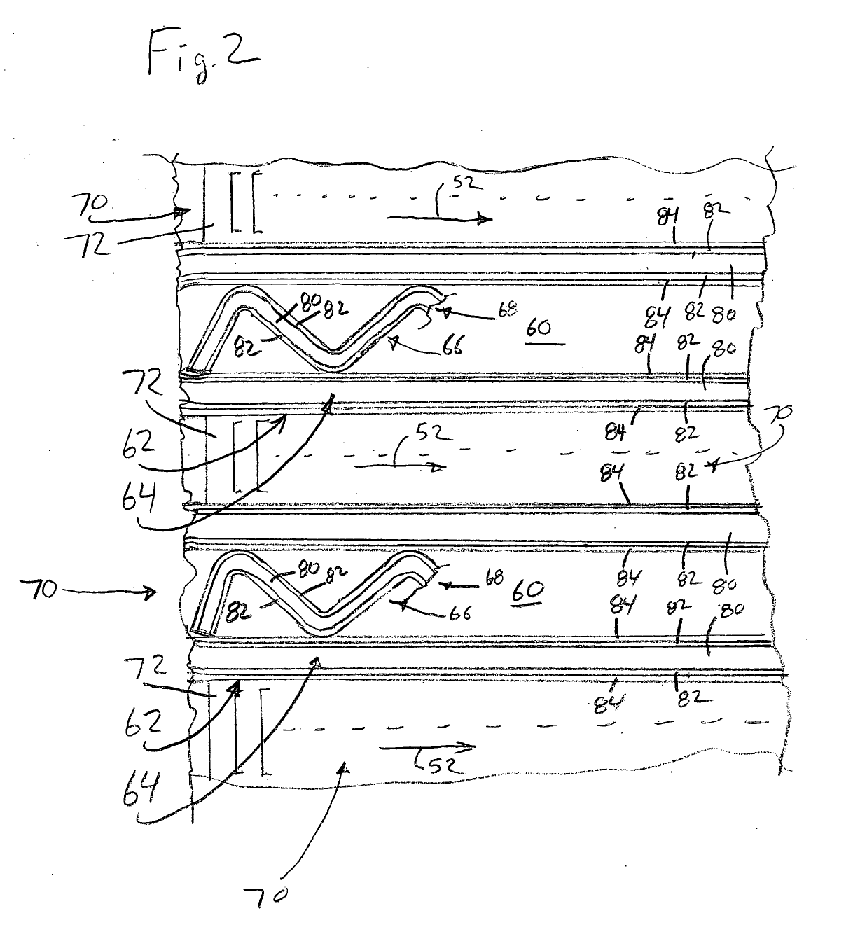

Turning now in more detail to the charge air cooler 20, with reference to FIG. 2, it can be seen that the intake gas flow path 50 through the charge air cooler is made up of a number of flow passages 60 (only two shown) with each of the flow passages 60 defined within the interior of a tube 62 formed from a multi-layer material 64, with a turbulator or serpentine fin 66 (only partially shown in FIG. 2 for purposes of illustration), also formed from a multi-layer material 68, bonded to the interior side walls of the tube 62 to enhance heat transfer. The cooling fluid flow path 52 is defined by the spaces 70 between adjacent tubes 62, with louvered fins 72 (only part of the louvers shown in FIG. 2) located in the spaces 70 to enhance heat transfer. It should be appreciated that any suitable fin or flow enhancement may be used for the fins 66 and 72.

FIG. 2 shows an embodiment wherein the multi-layer material 64 of the tube 62 includes five layers, whereas the multi-layer material 68 of the fin 66 has only three layers. Both of the multi-layer materials 64 and 68, include a core layer 80 that is formed from a corrosion resistant aluminum, which is preferably a modified 3003 material that is formulated for corrosion resistance. In a highly preferred embodiment, the material of the core layer 80 is a modified 3000 series aluminum manganese alloy. In a very highly preferred embodiment, the core material is Alcoa 0359 with a composition of:
0.20% maximum by weight of silicon;
0.35% maximum by weight of iron;
0.40% to 0.60% by weight copper;
1.0% to 1.3% by weight manganese;
0.20% to 0.30% by weight magnesium;
0.05% maximum by weight zinc;
0.10% to 0.25% by weight titanium;
with the balance being aluminum.

Both of the multi-layer materials 64 and 68 also include two liner layers 82 that overlay each side of the core layer 70. These liner layers are made of a high purity aluminum having no more than 0.4% by weight of impurities other than silicon, and in a highly preferred embodiment, the impurities are in the range of 0.3% to 0.1% by weight. One example of highly pure aluminum is so-called “smelter metal” which has 0.3% or less by weight of impurities other than silicon, with the impurities being 0.2% by weight or less of iron and 0.1% by weight or less of silicon. The liner layers 82 of highly pure aluminum helps prevent corrosion, and particularly general corrosion, by greatly limiting the potential corrosion sites that are created by impurities in the aluminum material. Furthermore, the liner layers 82 are sacrificial to the core layer 80, thereby offering excellent pitting corrosion protection. For the five layer multi-layer material 64, corrosion protection is further enhanced by two outer layers 84 of braze cladding that overlie the liner layers 82. The braze cladding can be any suitable braze clad material for either vacuum braze or controlled atmosphere brazing (CAB). In highly preferred embodiments, the braze cladding is selected from the group of 4000 series aluminum silicon alloys, with, for example, 4343 aluminum silicon alloy being used if CAB brazing is utilized, and 4104 aluminum silicon alloy being used if vacuum brazing is to be utilized. The braze cladding serves to form braze joints within the CAC 30 when it is brazed during assembly, which enhances both the strength and heat transfer properties of the CAC 30. In this regard, it should be noted that the layers 84 tend to dissipate significantly after brazing thereby leaving only a somewhat residual outer layer 84 of braze material in the finished charge air cooler 20. Preferably, after brazing, the braze cladding of these outer layers 84 leaves a thin residual alpha aluminum layer (other than at the braze joints) having approximately similar electrochemical potential as the high purity aluminum of the liner layers 72.

The relative thickness of each of the materials will be highly dependent on the particular parameters of each application, including for example, the material selected for the core layer 80, the material selected for the outer layers 84, and the method of forming the tubes 62. In one preferred embodiment, for the three layer material 68, the percentage of the total thickness of the material 68 for the liner layer is 10%±5%, and the core layer is 80%±10%. In another preferred embodiment, for the five layer material 64, the percentage thickness of each of the outer layers 84 is 10%±5%, the percentage thickness of each of the liner layers 82 is 10%±5%, and the core layer is the remainder of the thickness. It should be appreciated that the above-described percentage thicknesses are measured before brazing of the material, because after the material is brazed into the CAC 30, the outer layers 84 will be drawn into the brazed joints, thereby making the outer layers 84 much thinner.

The embodiment of FIG. 2 lends itself particularly well to a welded tube that is formed from a piece of sheet material. While the 5-layer multi-layer material 64 could have been used for the fins 66, it isn't required because the outer layer 84 of the material 64 of the tube 62 provides the braze cladding required to form the braze joints between the fins 66 and the interior of the tubes 62. Another option is to form the fins 66 from the 5-layer material 64 and the tubes 62 from a homogenous, corrosion resistant, extruded aluminum alloy material. In this option, the material 64 of the fins 66 will provide the braze cladding required to form the braze joints between the fins 66 and the tubes 62. As another option, the five layer material 64 could be used for the tube, with a single layer of material being used for the fin.

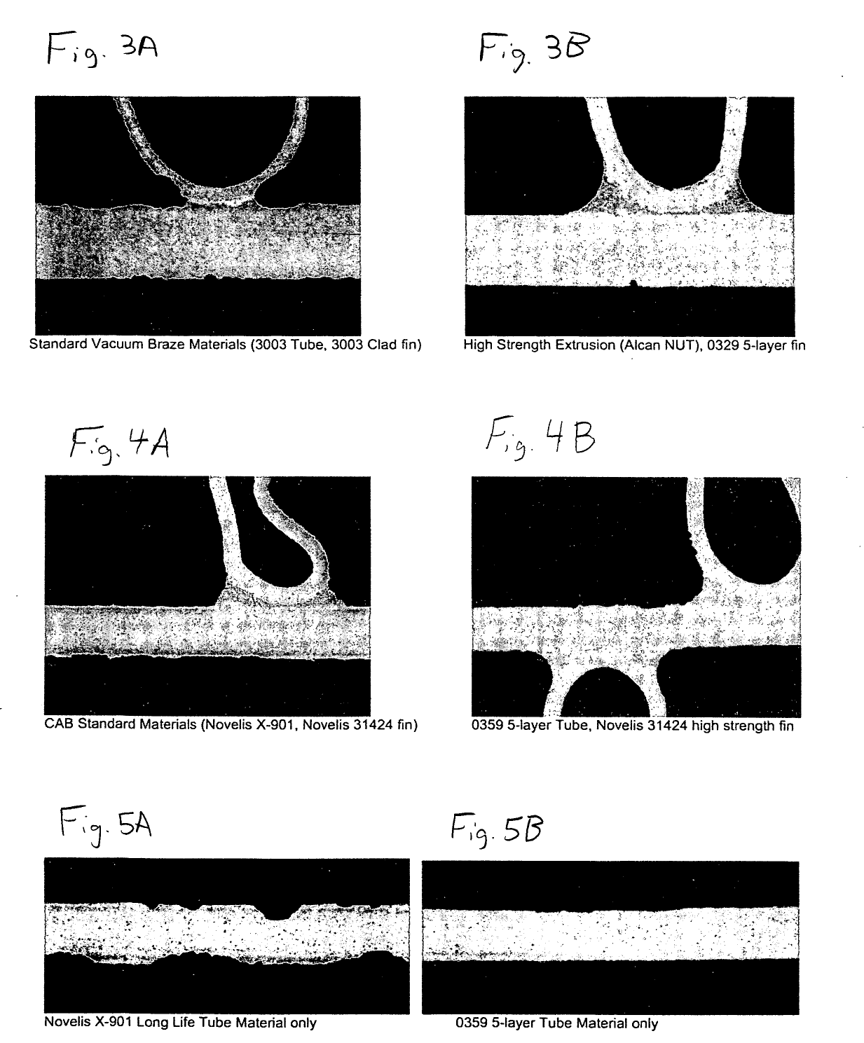

Wet/dry cycle testing was performed on coupon samples, with the coupon samples being placed in a beaker filled with a synthetic condensate (50 PPM nitrate, 20 PPM sulfate, pH 2.9). The condensate was evaporated by placing it in an oven at 200° C., with the sample being automatically refilled every two hours, for a total test time of 500 hours. FIGS. 3A and 3B, 4A and 4B, and 5A and 5B show magnified sections of the test coupons, with the “A” figures showing the coupons made from conventional aluminum materials, and the “B” figures showing the comparative coupon samples that utilize multi-layer materials 64 or 68, as noted in the captions underneath the figures. As seen in the figures, the coupon samples of the “B” figures show a notably less corrosion in comparison to the samples in the “A” figures.

1. A diesel combustion engine system comprising:
a diesel combustion engine including an intake gas manifold for directing an intake gas flow to the engine for combustion and an exhaust gas manifold for directing a combustion exhaust gas flow from the engine;
an exhaust gas driven turbine connected to the exhaust manifold to receive pressurized exhaust gas flow therefrom;
an exhaust gas recirculation loop connected to the turbine to receive reduced pressure exhaust gas flow therefrom, the exhaust gas recirculation loop including an exhaust gas cooler;
an intake gas compressor connected to an air inlet and the exhaust gas recirculation loop to receive an intake gas flow comprising an air flow from the air inlet and a cooled exhaust gas flow from the exhaust gas recirculation loop, the intake gas compressor driven by the turbine to provide a pressurized flow of the intake gas; and
a charge air cooler connected to the compressor to receive the pressurized intake gas flow therefrom and to the intake manifold to supply a cooled pressurized intake gas flow thereto, the cooler including an intake gas flow path for directing the intake gas flow in heat exchange relation with a cooling fluid flow through the cooler, the intake gas flow path defined by a five layer material having an inner surface wetted by the intake gas flow, the five layers of the material consisting of a core layer of corrosion resistant aluminum, a pair of liner layers of high purity aluminum having no more than 0.4% by weight of impurities other than silicon located against either side of the core layer, and two outer layers of braze cladding, one outer layer overlying the one of the liner layers and the other outer layer overlying the other of the liner layers.

2. The diesel combustion engine system of claim 1 wherein the braze cladding is selected from the group consisting of 4000 series aluminum silicon alloys.

3. The diesel combustion engine system of claim 1 wherein the core layer is a modified 3000 series aluminum manganese alloy.

4. The diesel combustion engine system of claim 1 wherein the composition of the core layer comprises:
0.20% maximum by weight of silicon;
0.35% maximum by weight of iron;
0.40% to 0.60% by weight copper;
1.0% to 1.3% by weight manganese;
0.20% to 0.30% by weight magnesium;
0.05% maximum by weight zinc;
0.10% to 0.25% by weight titanium; and
the balance being aluminum.

5. The diesel combustion engine system of claim 1 wherein the high purity aluminum has no more than 0.3% by weight of impurities other than silicon.

6. A diesel combustion engine system comprising:
a diesel combustion engine including an intake gas manifold for directing an intake gas flow to the engine for combustion and an exhaust gas manifold for directing a combustion exhaust gas flow from the engine;
an exhaust gas driven turbine connected to the exhaust manifold to receive pressurized exhaust gas flow therefrom;
an exhaust gas recirculation loop connected to the turbine to receive reduced pressure exhaust gas flow therefrom, the exhaust gas recirculation loop including an exhaust gas cooler;
an intake gas compressor connected to an air inlet and the exhaust gas recirculation loop to receive an intake gas flow comprising an air flow from the air inlet and a cooled exhaust gas flow from the exhaust gas recirculation loop, the intake gas compressor driven by the turbine to provide a pressurized flow of the intake gas;
a charge air cooler connected to the compressor to receive the pressurized intake gas flow therefrom and to the intake manifold to supply a cooled pressurized intake gas flow thereto, the cooler including an intake gas flow path for directing the intake gas flow in heat exchange relation with a cooling fluid flow through the cooler, the intake gas flow path defined by a multi-layer material having an inner surface that is wetted by the intake gas flow, the multi-layer material having a core layer of corrosion resistant aluminum sandwiched between two layers of high purity aluminum having no more than 0.4% by weight of impurities other than silicon.

7. The diesel combustion engine system of claim 6 wherein the multi-layer material further comprises at least one outer layer of braze cladding.

8. The diesel combustion engine system of claim 6 wherein the core layer is a modified 3000 series aluminum manganese alloy.

9. The diesel combustion engine system of claim 6 wherein the composition of the core layer comprises:
0.20% maximum by weight of silicon;
0.35% maximum by weight of iron;
0.40% to 0.60% by weight copper;
1.0% to 1.3% by weight manganese;
0.20% to 0.30% by weight magnesium;
0.05% maximum by weight zinc;
0.10% to 0.25% by weight titanium;
with the balance being aluminum.

10. The diesel combustion engine system of claim 6 wherein the high purity aluminum has no more than 0.3% by weight of impurities other than silicon.

11. A low pressure exhaust gas recirculation system for use with a diesel combustion engine having an intake gas manifold for directing an intake gas flow to the engine for combustion and an exhaust gas manifold for directing a combustion exhaust gas flow from the engine, the system comprising:
an exhaust gas driven turbine connected to the exhaust manifold to receive pressurized exhaust gas flow therefrom;
an exhaust gas recirculation loop connected to the turbine to receive reduced pressure exhaust gas flow therefrom, the exhaust gas recirculation loop including an exhaust gas cooler;
an intake gas compressor connected to an air inlet and the exhaust gas recirculation loop to receive an intake gas flow comprising an air flow from the air inlet and a cooled exhaust gas flow from the exhaust gas recirculation loop, the intake gas compressor driven by the turbine to provide a pressurized flow of the intake gas;
a charge air cooler connected to the compressor to receive the pressurized intake gas flow therefrom and to the intake manifold to supply a cooled pressurized intake gas flow thereto, the cooler including an intake gas flow path for directing the intake gas flow in heat exchange relation with a cooling fluid flow through the cooler, the intake gas flow path defined by a five layer material having an inner surface wetted by the intake gas flow, the five layers of the material consisting of a core layer of corrosion resistant aluminum, a pair of liner layers of high purity aluminum having no more than 0.4% by weight of impurities other than silicon located against either side of the core layer, and two outer layers of braze cladding, one outer layer overlying the one of the liner layers and the other outer layer overlying the other of the liner layers.

12. The low pressure exhaust gas recirculation system of claim 11 wherein the braze cladding is selected from the group consisting of 4000 series aluminum silicon alloys.

13. The low pressure exhaust gas recirculation system of claim 11 wherein the core layer is a modified 3000 series aluminum manganese alloy.

14. The low pressure exhaust gas recirculation system of claim 11 wherein the composition of the core layer comprises:
0.20% maximum by weight of silicon;
0.35% maximum by weight of iron;
0.40% to 0.60% by weight copper;
1.0% to 1.3% by weight manganese;
0.20% to 0.30% by weight magnesium;
0.05% maximum by weight zinc;
0.10% to 0.25% by weight titanium;
with the balance being aluminum.

15. The low pressure exhaust gas recirculation system of claim 11 wherein the high purity aluminum has no more than 0.3% by weight of impurities other than silicon.

16. A low pressure exhaust gas recirculation system for use with a diesel combustion engine having an intake gas manifold for directing an intake gas flow to the engine for combustion and an exhaust gas manifold for directing a combustion exhaust gas flow from the engine, the system comprising:
an exhaust gas driven turbine connected to the exhaust manifold to receive pressurized exhaust gas flow therefrom;
an exhaust gas recirculation loop connected to the turbine to receive reduced pressure exhaust gas flow therefrom, the exhaust gas recirculation loop including an exhaust gas cooler;
an intake gas compressor connected to an air inlet and the exhaust gas recirculation loop to receive an intake gas flow comprising an air flow from the air inlet and a cooled exhaust gas flow from the exhaust gas recirculation loop, the intake gas compressor driven by the turbine to provide a pressurized flow of the intake gas;
a charge air cooler connected to the compressor to receive the pressurized intake gas flow therefrom and to the intake manifold to supply a cooled pressurized intake gas flow thereto, the cooler including an intake gas flow path for directing the intake gas flow in heat exchange relation with a cooling fluid flow through the cooler, the intake gas flow path defined by a multi-layer material having an inner surface that is wetted by the intake gas flow, the multi-layer material having a core layer of corrosion resistant aluminum sandwiched between two layers of high purity aluminum having no more than 0.4% by weight of impurities other than silicon.

17. The low pressure exhaust gas recirculation system of claim 16 wherein the multi-layer material further comprises at least one outer layer of braze cladding.

18. The low pressure exhaust gas recirculation system of claim 16 wherein the core layer is a modified 3000 series aluminum manganese alloy.

19. The low pressure exhaust gas recirculation system of claim 16 wherein the composition of the core layer comprises:
0.20% maximum by weight of silicon;
0.35% maximum by weight of iron;
0.40% to 0.60% by weight copper;
1.0% to 1.3% by weight manganese;
0.20% to 0.30% by weight magnesium;
0.05% maximum by weight zinc;
0.10% to 0.25% by weight titanium; and
the balance being aluminum.

20. The low pressure exhaust gas recirculation system of claim 16 wherein the high purity aluminum has no more than 0.3% by weight of impurities other than silicon.

21. A diesel combustion engine system comprising:
a diesel combustion engine including an intake gas manifold for directing an intake gas flow to the engine for combustion and an exhaust gas manifold for directing a combustion exhaust gas flow from the engine;
an exhaust gas driven turbine connected to the exhaust manifold to receive pressurized exhaust gas flow therefrom;
an exhaust gas recirculation loop connected to the turbine to receive reduced pressure exhaust gas flow therefrom, the exhaust gas recirculation loop including an exhaust gas cooler;
an intake gas compressor connected to an air inlet and the exhaust gas recirculation loop to receive an intake gas flow comprising an air flow from the air inlet and a cooled exhaust gas flow from the exhaust gas recirculation loop, the intake gas compressor driven by the turbine to provide a pressurized flow of the intake gas;
a charge air cooler connected to the compressor to receive the pressurized intake gas flow therefrom and to the intake manifold to supply a cooled pressurized intake gas flow thereto, the cooler including an intake gas flow path for directing the intake gas flow in heat exchange relation with a cooling fluid flow through the cooler, the intake gas flow path defined by a multi-layer material having an inner surface that is wetted by the intake gas flow, the multi-layer material having a core layer of corrosion resistant aluminum and a layer of high purity aluminum having no more than 0.4% by weight of impurities other than silicon, the layer of high purity aluminum being on the same side of the core layer as the inner surface.

22. The diesel combustion engine system of claim 21 wherein the multi-layer material further comprises an outer layer of braze cladding defining the inner surface.

23. The diesel combustion engine system of claim 21 wherein the core layer is a modified 3000 series aluminum manganese alloy.

24. The diesel combustion engine system of claim 21 wherein the composition of the core layer comprises:
0.20% maximum by weight of silicon;
0.35% maximum by weight of iron;
0.40% to 0.60% by weight copper;
1.0% to 1.3% by weight manganese;
0.20% to 0.30% by weight magnesium;
0.05% maximum by weight zinc;
0.10% to 0.25% by weight titanium; and
the balance being aluminum.

25. The diesel combustion engine system of claim 21 wherein the high purity aluminum has no more than 0.3% by weight of impurities other than silicon.

26. A low pressure exhaust gas recirculation system for use with a diesel combustion engine having an intake gas manifold for directing an intake gas flow to the engine for combustion and an exhaust gas manifold for directing a combustion exhaust gas flow from the engine, the system comprising:
an exhaust gas driven turbine connected to the exhaust manifold to receive pressurized exhaust gas flow therefrom;
an exhaust gas recirculation loop connected to the turbine to receive reduced pressure exhaust gas flow therefrom, the exhaust gas recirculation loop including an exhaust gas cooler;
an intake gas compressor connected to an air inlet and the exhaust gas recirculation loop to receive an intake gas flow comprising an air flow from the air inlet and a cooled exhaust gas flow from the exhaust gas recirculation loop, the intake gas compressor driven by the turbine to provide a pressurized flow of the intake gas;
a charge air cooler connected to the compressor to receive the pressurized intake gas flow therefrom and to the intake manifold to supply a cooled pressurized intake gas flow thereto, the cooler including an intake gas flow path for directing the intake gas flow in heat exchange relation with a cooling fluid flow through the cooler, the intake gas flow path defined by a multi-layer material having an inner surface that is wetted by the intake gas flow, the multi-layer material having a core layer of corrosion resistant aluminum and a layer of high purity aluminum having no more than 0.4% by weight of impurities other than silicon, the layer of high purity aluminum being on the same side of the core layer as the inner surface.

27. The low pressure exhaust gas recirculation system of claim 26 wherein the multi-layer material further comprises an outer layer of braze cladding defining the inner surface.

28. The low pressure exhaust gas recirculation system of claim 26 wherein the core layer is a modified 3000 series aluminum manganese alloy.

29. The low pressure exhaust gas recirculation system of claim 26 wherein the composition of the core layer comprises:
0.20% maximum by weight of silicon;
0.35% maximum by weight of iron;
0.40% to 0.60% by weight copper;
1.0% to 1.3% by weight manganese;
0.20% to 0.30% by weight magnesium;
0.05% maximum by weight zinc;
0.10% to 0.25% by weight titanium;
with the balance being aluminum.

30. The low pressure exhaust gas recirculation system of claim 26 wherein the high purity aluminum has no more than 0.3% by weight of impurities other than silicon.
